(19) United States
(12) Patent Application Publication
(10) Pub. No.: US 2018/0281490 A1
(43) Pub. Date: Oct. 4, 2018

(54) Printing Apparatus

(71) Applicant: Brother Kogyo Kabushiki Kaisha, Nagoya-shi (JP)

(72) Inventor: Kazuma Hojo, Inazawa-shi (JP)

(21) Appl. No.: 15/924,416

(22) Filed: Mar. 19, 2018

(30) Foreign Application Priority Data
Mar. 31, 2017 (JP) 2017-072802

(51) Int. Cl. B41J 35/08; B41J 2/325; B41J 32/00; B41J 35/38; B65H 18/10; B65H 23/16

(52) U.S. Cl. CPC B41J 35/08; B41J 2/325; B65H 23/16; B41J 35/38; B65H 18/103; B41J 32/00

(57) ABSTRACT

A printing apparatus includes: a ribbon supply roll; a thermal head that heats an ink ribbon fed out from the ribbon supply roll and thereby transfers an ink onto an image receiving body; a ribbon take-up roll that takes up the ink ribbon after transfer of the ink; a supply side guide member disposed to be displaced in a direction orthogonal to an axial direction, so as to changeably apply tension to the ink ribbon by biasing force of a supply side spring member; and a take-up side guide member disposed to be displaced in a direction orthogonal to an axial direction, so as to changeably apply tension to the ink ribbon by biasing force of a take-up side spring member. A spring constant of the supply side spring member is different from a spring constant of the take-up side spring member.

### CROSS REFERENCE TO RELATED APPLICATION

The present application claims priority from Japanese Patent Application No. 2017-072802 filed on Mar. 31, 2017, the disclosure of which is incorporated herein by reference in its entirety.

### BACKGROUND

### Field of the Invention

The present invention relates to a heat transfer type printing apparatus that performs printing by heating an ink ribbon.

### Description of the Related Art

In a thermal printer, an ink ribbon is conveyed from a supply side reel to a take-up side reel. In this process, when a crease or slack occurs in the ink ribbon at least during transfer of an ink by a thermal head, a clean printing result cannot be obtained. Accordingly, there is known a technology in which a tension applying mechanism is disposed with respect to a guide roller in a midway section of a conveyance path, and a tension is applied to the ink ribbon during conveyance, thereby preventing occurrence of the crease or slack in the ink ribbon.

### SUMMARY

Now, the tension that should be applied to the ink ribbon differs according to a width of the ink ribbon being used. If it is attempted to cope by one kind of spring member as in the above-described technology, then there is a need to either greatly displace the spring member or use a spring member with a high spring constant. Moreover, a need arises for a plurality of gears to be interposed in order to prevent a sudden change in tension. As a result, a structure becomes complex, hence an installation space needs to be secured in large measure.

Note that the ink ribbon may be divided into a supply side and a take-up side with reference to the thermal head. It is also conceivable to configure so that, by disposing the same tension applying mechanism on both of these supply side and take-up side and preventing occurrence of the crease or slack not only on the supply side but also on the take-up side of the ink ribbon, the crease or slack occurring on the take-up side does not extend to the thermal head.

However, in the case of simply disposing tension applying mechanisms employing springs of the same spring constant, there is a possibility that a required tension cannot be applied to the ink ribbon. Moreover, there is a possibility that even supposing the tension can be applied to the ink ribbon, a margin cannot be secured with respect to a movable region of the guide member, and the tension is applied suddenly to the ink ribbon.

An object of the present teaching is to provide a printing apparatus that enables a wide range of tensions to be applied to an ink ribbon.

According to an aspect of the present teaching, there is provided a printing apparatus including: a ribbon supply roll configured to supply an ink ribbon; a thermal head configured to print on an image receiving body, the thermal head being configured to heat the ink ribbon fed out from the ribbon supply roll and thereby transfer an ink onto the image receiving body from the ink ribbon; a ribbon take-up roll configured to take up the ink ribbon after transfer of the ink; a supply side guide member of shaft-like shape disposed in at least one place in a supply side conveyance path along which the ink ribbon is conveyed to the thermal head from the ribbon supply roll, the supply side guide member being configured to guide the ink ribbon and being disposed to be displaced in a direction orthogonal to an axial direction thereof, so as to changeably apply tension to the ink ribbon by biasing force of a supply side spring member; and a take-up side guide member of shaft-like shape disposed in at least one place in a take-up side conveyance path along which the ink ribbon is conveyed to the ribbon take-up roll from the thermal head, the take-up side guide member being configured to guide the ink ribbon and being disposed to be displaced in a direction orthogonal to an axial direction thereof, so as to changeably apply tension to the ink ribbon by biasing force of a take-up side spring member, wherein a spring constant of the supply side spring member is different from a spring constant of the take-up side spring member, and the printing apparatus further comprising a supply side restricting section and a take-up side restricting section that are configured to restrict displacement of the supply side guide member and displacement of the take-up side guide member, in order, at certain positions, according to the spring constant of the supply side spring member and the spring constant of the take-up side spring member.

In the printing apparatus of the teaching of the present application, a variety of ink ribbons are selectively used according to a kind of image receiving body.

Generally, a tension applied in order to maintain a tensioned state of an ink ribbon differs according to a width of the ink ribbon. Therefore, the printing apparatus of the teaching of the present application is configured so as to apply a tension as appropriate as possible to the width of the ink ribbon. That is, guide members capable of being displaced so as to apply a tension to the ink ribbon are disposed in at least one place of a supply side conveyance path supplying the ink ribbon to a thermal head from a ribbon supply roll and at least one place of a take-up side conveyance path reaching from the thermal head to a ribbon take-up roll, and the guide members are biased by spring members. Moreover, there are provided restricting sections that restrict displacements of these guide members, in order, at certain positions based on spring constants of the spring members.

Different spring members having different spring constants, particularly the spring member having the lower spring constant, make it possible for a longer stroke (in an extending direction) to be secured with respect to the entire conveyance path reaching from the supply side roll to the take-up side roll via the thermal head, compared to when spring members of one kind (having the same spring constants) are employed or a spring member is employed only on one side. Moreover, a situation of a tension being applied suddenly to the ink ribbon can be relieved. Moreover, when the ink is transferred to the image receiving body by the thermal head, displacement of one of the guide members whose orders have been predetermined is restricted first at a certain position, and further change in biasing force from the guide member is stopped. As a result, it is possible to change to a state where the ink ribbon is biased by the other of the guide members only. In other words, a magnitude of the tension applied to the ink ribbon can be changed over a wide range.

In the present teaching, the spring constant of a supply side spring member and the spring constant of a take-up side spring member differ. Moreover, there are provided a supply side restricting section and a take-up side restricting section that restrict displacements of the supply side guide member and the take-up side guide member, in order, at certain positions based on the spring constant of the supply side spring member and the spring constant of the take-up side spring member. As a result, a wide range of tensions can be applied to the ink ribbon. In other words, the magnitude of the tension applied to the ink ribbon can be changed over a wide range.

### BRIEF DESCRIPTION OF THE DRAWINGS

FIG. 1 is an explanatory view depicting one example of a relationship between a printing apparatus and an operating means.

FIG. 2 is a side view of a printing unit incorporated in the printing apparatus.

FIG. 3 is a side view of a cartridge.

FIG. 4 is a perspective view from a front direction of the cartridge.

FIG. 5 is a perspective view from a rear direction of the cartridge.

FIG. 6 is a side view of a cartridge base.

FIG. 7 is a perspective view from a front direction of the cartridge base.

FIG. 8 is a rear view of the cartridge base.

FIG. 9 is a front view of the cartridge base.

FIG. 10 is a schematic view of the printing apparatus.

FIG. 11A is a perspective view depicting an example of configuration of a middle section from the rear direction of a tension applying mechanism, and FIG. 11B is a side view depicting the example of configuration of the middle section of the tension applying mechanism.

FIG. 12 is a graph depicting a relationship between displacement and force in spring members having different spring constants.

FIG. 13 is a graph depicting a relationship between displacement and force when there are two spring members having the same spring constant and when there are two spring members having different spring constants.

FIG. 14 is a graph depicting application of tension to ribbons whose ribbon widths may differ from each other.

### DESCRIPTION OF THE EMBODIMENTS

An embodiment of a printing apparatus according to the present teaching will be described below with reference to the drawings.

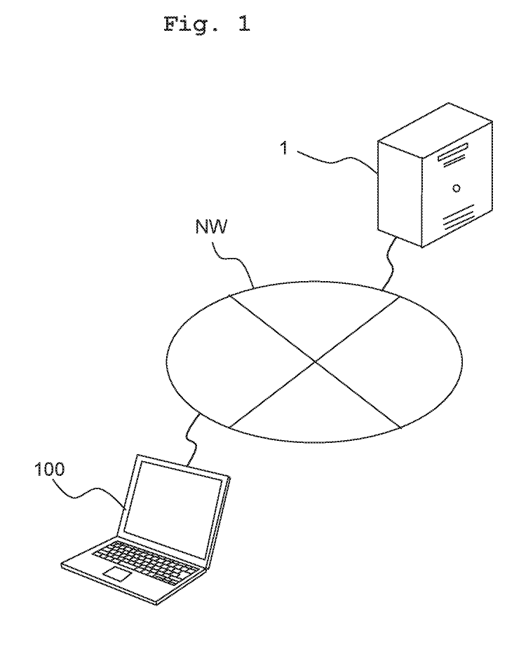

As depicted in FIG. 1, a printing apparatus 1 in this example is connected to an external device 100 such as a personal computer (a so-called notebook computer) as an operating means, via a network line NW. The printing apparatus 1 executes a desired print processing based on print data outputted from the external device 100. The external device 100 has operating devices such as a keyboard, a mouse, and a monitor.

Note that the external device 100 as the operating means is not limited to a personal computer. An operating section having the likes of a keyboard or a monitor screen may be provided as the operating means in the printing apparatus 1.

Moreover, the printing apparatus 1 and the external device 100 may be directly connected using the likes of a serial cable, for example, in addition to various kinds of wireless or wired network lines (intranet/internet).

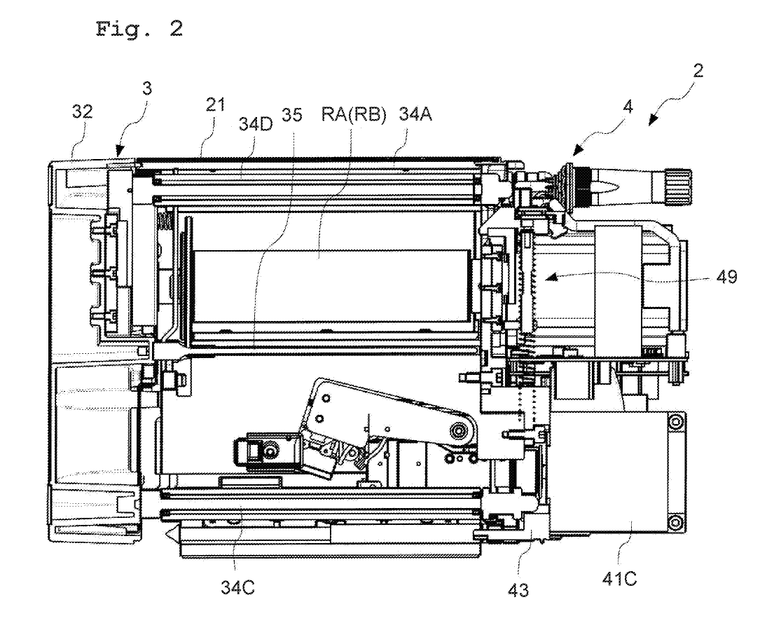

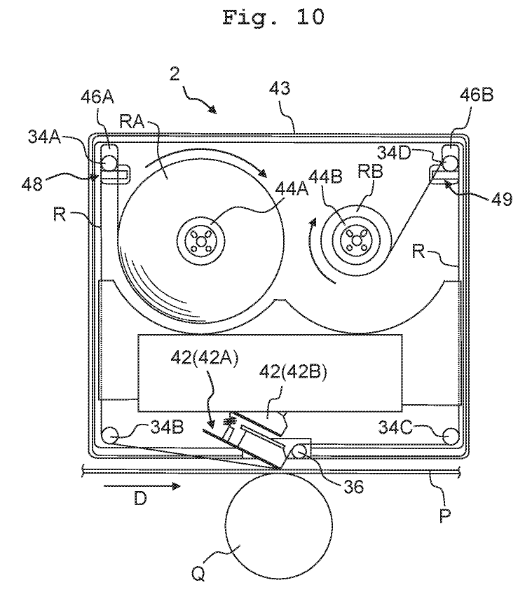

The printing apparatus 1 houses: a heat transfer type printing unit 2 (refer to FIG. 2) that employs an ink ribbon R; and a conveyance unit (not illustrated) that conveys a sheet form image receiving body P on a platen roller Q (refer to FIG. 10), that will be mentioned later. The printing unit 2 has a box shaped casing 21. The casing 21 covers body portions of a cartridge 3 and a cartridge base 4 that are detachably installed so as to abut on each other.

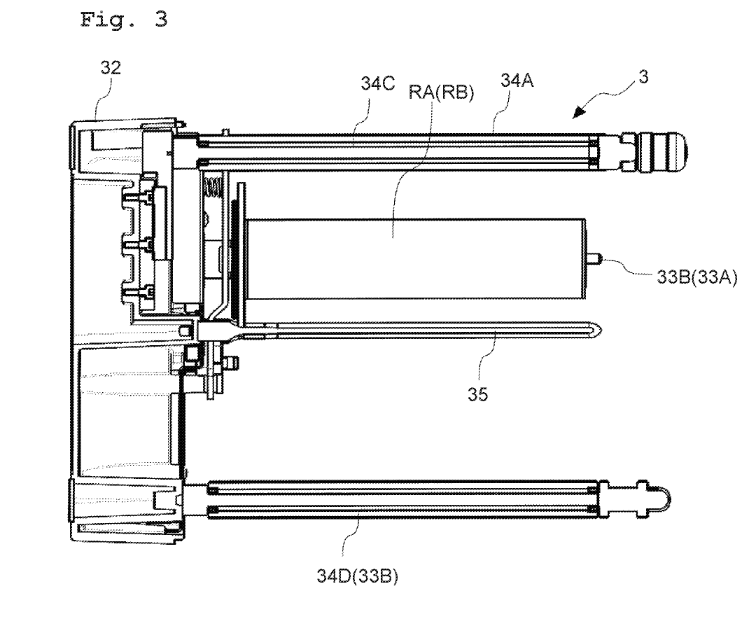

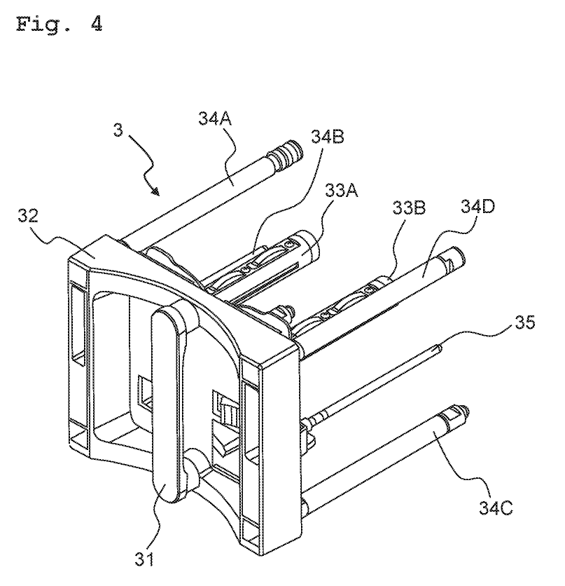

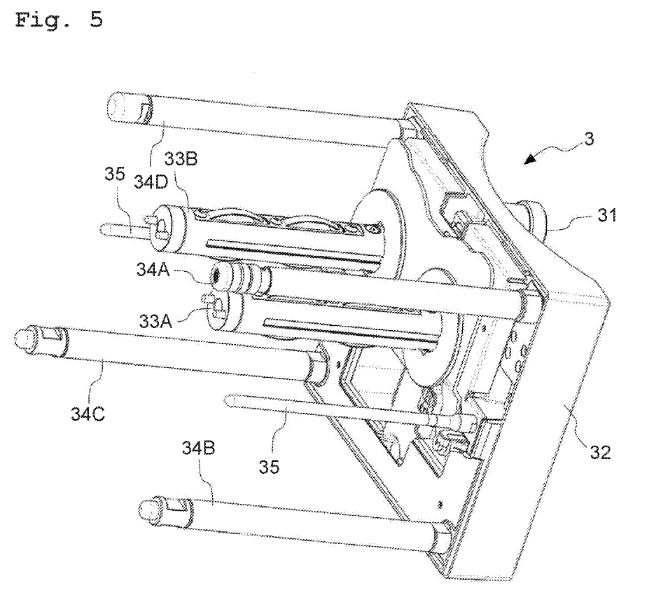

As depicted in FIGS. 3 to 5, the cartridge 3 mainly includes: a grip 31; a holder section 32 which is substantially rectangular in front view; two roll shafts 33A, 33B; four shaft-like guide members 34A-34D; and a shaft-like positioning shaft 35, The grip 31 is provided for a user to hold the cartridge 3 in their hand when attaching/detaching the cartridge 3 to/from the cartridge base 4 (during ribbon exchange, and so on). The grip 31 is provided on a front side of the holder section 32. The two roll shafts 33A, 33B are erected perpendicularly from the holder section 32 on a rear side of the holder section 32, that is, on an inner side covered by the casing 21 of the printing unit 2, of the holder section 32. The four shaft-like guide members 34A-34D are erected in parallel with the roll shafts 33A, 33B from vicinities of the four corners on the rear side of the holder section 32. The positioning shaft 35 is positioned more outwardly than the roll shafts 33A, 333, and is employed when installing the cartridge 3 in the cartridge base 4.

The two roll shafts 33A, 33B take up the belt-like ink ribbon R (refer to FIG. 2) in roll form with one side of both ends of the ink ribbon R as a supply side and the other side of both ends of the ink ribbon R as a take-up side. That is, one roll shaft 33A functions as a ribbon supply roll shaft 33A that has the supply side of the ink ribbon R arranged wound in roll form. The other roll shaft 33B functions as a ribbon take-up roll shaft 33B that takes up the take-up side of the ink ribbon R in roll form.

The guide members 34A, 349 are disposed close to the ribbon supply roll shaft 33A. The guide members 34A, 34B function as supply side guide members 34A, 34B that abut on the ink ribbon R and guide the ink ribbon R in a conveyance direction orthogonal to an axial direction along a width direction of the ink ribbon R.

Similarly, the guide members 34C, 34D are disposed close to the ribbon take-up roll shaft 33B. The guide members 34C, 34D function as take-up side guide members 34C, 34D that abut on the ink ribbon R and guide the ink ribbon R in the conveyance direction orthogonal to the axial direction along the width direction of the ink ribbon R.

The holder section 32 supports each of the roll shafts 33A, 33B in an independently rotatable manner and supports each of the guide members 34A, 34D in a manner enabling their displacement in a direction orthogonal to the axial direction. That is, the holder section 32 supports the guide members 34A, 34D in a displaceable manner and supports the guide members 34B, 34C in a fixed state. Note that the guide members 34A-34D may be rotatable around their respective axes, that is, in a direction that accords with the conveyance direction of the ink ribbon R.

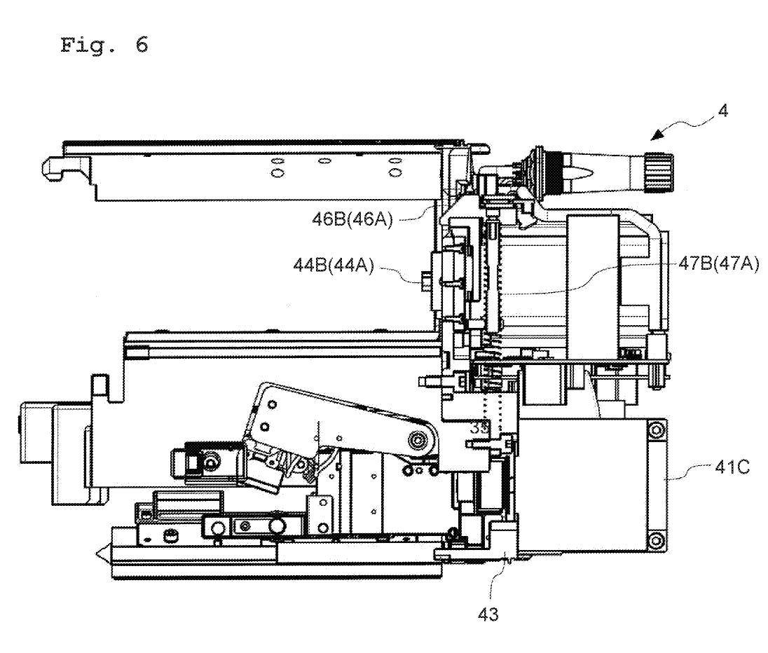

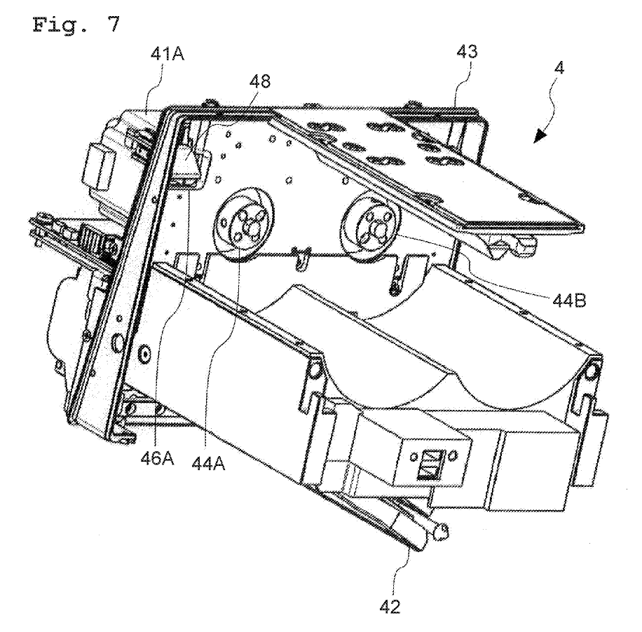

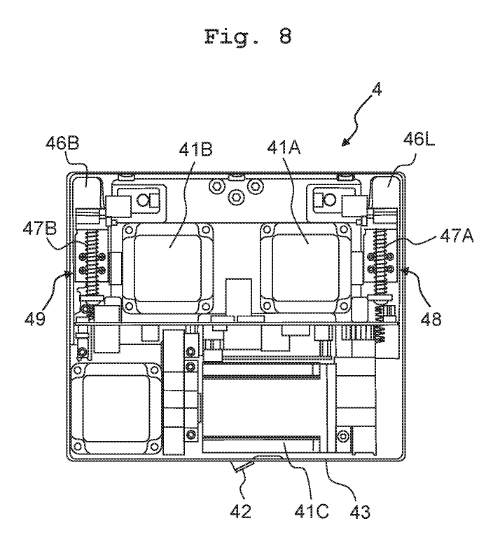

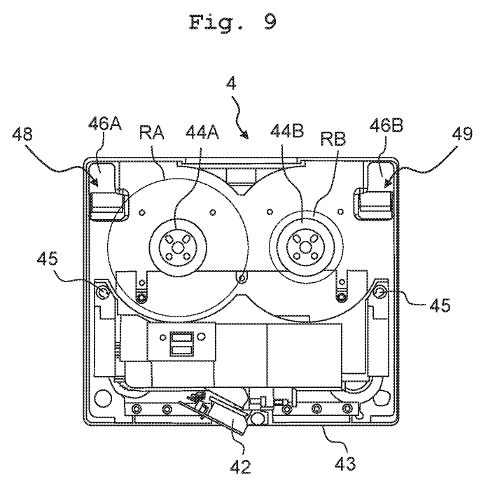

As depicted in FIGS. 6 to 10, the cartridge base 4 faces the holder section 32 on a rear side of the cartridge base 4, that is, on an inner side covered by the casing 21 of the printing unit 2, of the cartridge base 4. The cartridge base 4 has a holder section 43 which is substantially rectangular in front view. A front side of the holder section 43 is provided with a drive motor 41C which is for causing displacement of drive motors 41A, 41B that are for causing each of the roll shafts 33A, 33B to he independently rotary driven and which is for causing displacement also of a thermal head 42. A rear side of the holder section 43 is provided with a roll shaft receiving section 44A on the supply side, a roll shaft receiving section 44B on the take-up side, and an engagement hole 45. The roll shaft receiving section 44B on the supply side supports the ribbon supply roll shaft 33B in a state of being abutted on by a tip of the ribbon supply roll shaft 33A, so that a ribbon supply roll RA is arranged wound. The roll shaft receiving section 44B on the take-up side supports the ribbon take-up roll shaft 33B in a state of being abutted on by a tip of the ribbon take-up roll shaft 33B, so that a ribbon take-up roll RB is taken up. The engagement hole 45 engages with a tip of the positioning shaft 35. The holder section 43 has formed therein a supply side guide receiving section 46A and a take-up side guide receiving section 46B that support tips of each of the guide members 34A, 34D in a manner enabling penetration, so as to allow displacement of each of the guide members 34A, 34D. A supply side spring member 47A and a take-up side spring member 47B are disposed on a front side of the holder section 43, respectively adjacently to the supply side guide receiving section 46A and the take-up side guide receiving section 46B. The supply side spring member 47A and the take-up side spring member 47B changeably apply a tension to the ink ribbon R via the supply side guide member 34A and the take-up side guide member 34D. A spring constant of the supply side spring member 47A and a spring constant of the take-up side spring member 47B differ. Moreover, a rear side of the holder section 43 is provided with a supply side restricting section 50 and a take-up side restricting section 60 that restrict displacements of the supply side guide member 34A and the take-up side guide member 34D, in order, at certain positions based on the spring constants of each of the spring members 47A, 47B.

As depicted in FIG. 10, the ink ribbon R in roll form (a single strip) is installed in the printing unit 2. The ink ribbon R includes the supply side roll RA and the take-up side roll RB. Supply and take-up of the ink ribbon R are performed by the ribbon supply roll shaft 33A and the ribbon take-up roll shaft 33B of the cartridge 3. The ink ribbon R has a conveyance path that can be changed by the four guide members 34A-34D provided in the cartridge 3. The thermal head 42 as a printing means is disposed in a midway section of the conveyance path. The thermal head 42 is provided in the cartridge base 4. The thermal head 42 transfers an ink onto the image receiving body P conveyed between the platen roller Q and the thermal head 42. Of the four guide members 34A-34D, the guide members 34A, 34D guide the ink ribbon R so that the ink ribbon R is doubled back at an acute angle in vicinities of the supply side roll RA and the take-up side roll RB. The guide members 34A, 34D are configured so as to appropriately tension the ink ribbon R.

The thermal head 42 is capable of being brought close to and being retracted from the platen roller Q. Normally, the thermal head 42 is positioned in a retracted position (refer to symbol 42B) where it does not contact the ink ribbon R, whereas during printing, it presses the ink ribbon R toward the platen roller Q while contacting the ink ribbon R. Therefore, a guide bar 36 of the ink ribbon R is disposed in a vicinity of the thermal head 42, in the cartridge base 4. The guide bar 36 is positioned between the thermal head 42 and the guide member 34C in the conveyance path of the ink ribbon R, and is positioned between a bottom dead center of the thermal head 42 and the guide member 34C in relation to a height direction.

When the thermal head 42 is positioned in a printing standby position 42B, the ink ribbon R does not contact the guide bar 36. Therefore, the ink ribbon R at this time could also be said to be in a state where part thereof is retracted from the conveyance path.

Incidentally, in the above-mentioned printing apparatus, the printing unit 2 dividable into the cartridge 3 and the cartridge base 4 is employed in order to handle a plurality of kinds of ink ribbons R whose ribbon widths differ greatly.

However, one printing unit 2 may integrally include the above-described kind of cartridge 3 and cartridge base 4. That is, the printing apparatus may include: the ribbon supply roll RA that supplies the ink ribbon R; the thermal head 42 that prints on the image receiving body, the thermal head 42 heating the ink ribbon R fed out from the ribbon supply roll RA and thereby transferring the ink onto the image receiving body from the ink ribbon R; a ribbon take-up roll that takes up the ink ribbon R after transfer of the ink; the supply side guide member 34A of shaft-like shape disposed in at least one place in a supply side conveyance path along which the ink ribbon R is conveyed to the thermal head 42 from the ribbon supply roll RA, the supply side guide member 34A guiding the ink ribbon R and being disposed in a manner enabling displacement in a direction orthogonal to an axial direction, so as to changeably apply a tension to the ink ribbon R by a biasing force of the supply side spring member 47A; and the take-up side guide member 34D of shaft-like shape disposed in at least one place in a take-up side conveyance path along which the ink ribbon R is conveyed to the ribbon take-up roll from the thermal head 42, the take-up side guide member 34D guiding the ink ribbon R and being disposed in a manner enabling displacement in a direction orthogonal to an axial direction, so as to changeably apply a tension to the ink ribbon R by a biasing force of the take-up side spring member 47B, wherein the spring constant of the supply side spring member 47A and the spring constant of the take-up side spring member 47B may differ, and the printing apparatus may have the supply side restricting section 50 and the take-up side restricting section 60 that restrict displacements of the supply side guide member 34A and the take-up side guide member 34D, in order, at certain positions, according to the spring constant of the supply side spring member 47A and the spring constant of the take-up side spring member 47B.

The printing apparatus 1 is configured so that ink ribbons R of a variety of ribbon widths are selectively used according to a kind of the image receiving body P. The tension that should be applied to maintain a tensioned state of the ink ribbon R differs according to the ribbon width of the ink ribbon R being used. The printing apparatus 1 of the present embodiment is configured to apply a tension based on the ribbon width. That is, a guide member applying a tension to the ink ribbon R is disposed in at least one place of the supply side conveyance path by which the ink ribbon R is supplied from the ribbon supply roll RA to the thermal head 42 and in at least one place of the take-up side conveyance path reaching from the thermal head 42 to the ribbon take-up roll. The guide members are configured so as to undergo displacement by biasing forces of the spring members. Moreover, displacements of each of these guide members are restricted by restricting sections, in order, at certain positions based on the spring constants of each of the spring members.

As a result, for the entire conveyance path from the supply side roll via the thermal head 42 to the take-up side roll, it is possible to secure a longer stroke (in an extending direction) by different spring members having different spring constants, particularly, by the spring member having the lower spring constant, compared to when spring members of a single kind (having the same spring constant) are disposed on the supply side and the take-up side or when a spring member is disposed on only one of the supply side and the take-up side. Furthermore, a situation of a sudden tension being applied to the ink ribbon R can be relieved. Moreover, when the ink is transferred to the image receiving body by the thermal head 42, displacement of one of the guide members whose orders have been predetermined is restricted first at a certain position. Therefore, further change in biasing force from the spring member is stopped, and it is possible to change to biasing by the other of the guide members only. As a result, it becomes possible for a wide range of tensions to be applied to the ink ribbon R. in other words, magnitude of the tension applied to the ink ribbon R can be changed over a wide range.

By making the spring constant of the supply side spring member 47A smaller than the spring constant of the take-up side spring member 47B at this time, the tension can be configured changeable to the end with respect to the ink ribbon R and occurrence of slack of the ink ribbon R can be efficiently suppressed on the supply side where the spring constant is small. Note that when a plurality of spring members (for example, A, B, C) are disposed on one of the supply side or the take-up side, a spring member having the minimum spring constant in the individual spring members A, B, C, and not one configured having an overall spring constant, that is, a spring constant due to the plurality of spring members A, B, C, is disposed on the supply side.

Moreover, regarding the restricting sections 50, 60, by executing restriction on an upper limit side of the take-up side guide member 34D due to the take-up side restricting section 60 earlier than that due to the supply side restricting section 50, the tension can be configured changeable to the end with respect to the ink ribbon R and occurrence of slack of the ink ribbon R can be efficiently suppressed on the supply side where displacement of the supply side guide member 34A is restricted later.

Moreover, regarding the supply side guide member 34A and the take-up side guide member 34D, by configuring as an acute angle an intersection angle of imaginary lines joining the conveyance path on an upstream side and the conveyance path on a downstream side of the ink ribbon R, each of the guide members, in order to apply the tension to the ink ribbon R, conveys the ink ribbon R so as to be doubled back on the upstream side and the downstream side, whereby the tension can be efficiently applied.

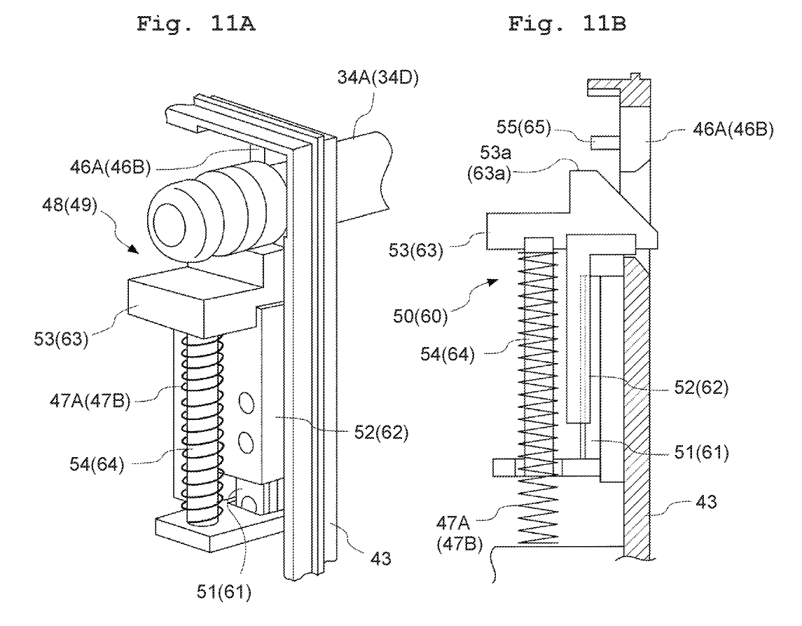

One specific example of tension application will be described below based on FIG. 11. Note that although the tension application example depicted in FIG. 11 illustrates the supply side restricting section 50, there is no apparent difference in configuration between the supply side restricting section 50 and the take-up side restricting section 60 besides the spring constants differing for the supply side spring member 47A and the take-up side spring member 47B. Therefore, in the description below, description of the take-up side restricting section 60 will be omitted, and only symbols thereof are assigned on the drawing. Therefore, it is assumed that where something is referred to as “supply side” in the actual description, this is replaced by “take-up side”.

The supply side restricting section 50 (60) includes: a guide rail 51 (61) extending in an up-down direction provided on the rear side of the holder section 43; a slider 52 (62) guided by the guide rail 51 (61); a displacement piece 53 (63) of substantially arrowhead shape fixed to the slider 52 (62); a displacement shaft 54 (64) having its upper end fixed to the displacement piece 53 (63) to penetrate the coil spring shaped supply side spring member 47A (47B); and a projecting section 55 (65) provided to the supply side guide receiving section 46A (46B) in a manner enabling it to be abutted on by an upper surface section 53a (63a) of the displacement piece 53 (63).

The upper surface section 53a (63a) of the displacement piece 53 (63) attempts to abut on the projecting section 55 (65) due to biasing in an extension direction of the supply side spring member 47A (47B), of the displacement piece 53 (63). On the other hand, the ink ribbon R attempts to cause the upper surface section 53a (63a) to separate from the projecting section 55 (65) by resisting the biasing of the displacement piece 53 (63) by the supply side spring member 47A (47B). When the upper surface section 53a (63a) abuts on the projecting section 55 (65), subsequent displacement of the displacement piece 53 (63) is restricted. Note that the projecting section 55 (65) projects from a side of an opening of the supply side guide receiving section 46A (46B) so as prevent displacement of the supply side guide member 34A (34D) being hindered.

As a result, the supply side guide member 34A (34D) that abuts on the upper surface section 53b (63b) of the displacement piece 53 (63) undergoes displacement in an integrated manner with displacement of the displacement piece 53 (63). In this way, tension applying mechanisms (the restricting sections 50, 60) employing the spring members 47A, 47B are respectively provided on a feed side and a take-up side conveying the ink ribbon R, and the spring members 47A, 47B are each disposed having different spring constants. Making different the spring constants of each of the spring members 47A, 47B results in a situation where when one of the spring members (for example, the supply side spring member 47A) is restricted by the restricting section (for example, the supply side restricting section 50), subsequent application of tension by that one of the spring members (the supply side spring member 47A) cannot be made to the ink ribbon R. As a result, the tension can be applied to the ink ribbon R using only the other of the spring members (for example, the take-up side spring member 47B), whereby the magnitude of the tension applied to the ink ribbon R can be changed over a wide range.

Generally, in order to obtain a good printing result, it is required to print in a state where a tension has been applied to the ink ribbon R. However, if ribbon widths (for example, 34 mm, 55 mm, 130 mm) of the ink ribbon R differ, then weights of the ink ribbon R will also greatly differ.

For example, if the tension that should be applied in the case of ribbon width being 34 mm is assumed to be 1, then the tension that should be applied in the case of ribbon width being 55 mm will be 1.61 times that, and the tension that should be applied in the case of ribbon width being 130 mm will be 3.82 times that.

Therefore, it is extremely difficult for tensions dealing with all of these ribbon widths to be applied by one kind of spring member. Moreover, even supposing it was possible to apply tensions to all kinds of ink ribbons R by one spring member, the spring constant of that spring member would have a small value. Moreover, in order to change the tension just a little, the need would arise to largely displace the guide member. As a result, control would become difficult.

An example of appropriate tension being applied by using the plurality of spring members (47A, 47B) will be described below. At this time, if spring members having the same spring constant are employed, then since each applies a tension uniformly to the ink ribbon R, the spring constant simply gets larger. That is, since a large displacement is required regardless of there being a small amount of change in tension, balance control (balance setting) of tension becomes difficult. Therefore, a plurality of spring members having different spring constants are used (for example, three spring constants a, b, c, where a<b<c).

In this case, first, displacement of the spring member whose spring constant is smallest (spring constant a) becomes mechanically maximum, and is restricted earliest by the restricting section (50, 60). Then, displacement of the spring member whose spring constant is next largest (spring constant b) becomes mechanically maximum, and is restricted by the restricting section (50, 60). In this way, displacements of the actually operating spring members are restricted in order from the spring member whose spring constant is small. Therefore, even if at first there is a small spring constant overall, tension can be applied by spring members having gradually larger spring constants (a+b+c→b+c→c). As a result, balance control of tension also becomes easy.

Furthermore, by the spring member being installed in the shaft-like guide member that doubles back the ink ribbon R at an acute angle, it is possible for a more appropriate tension to be applied, while considering the likes of magnitude of roll diameter of the ink ribbon R or conveyance resistance on the conveyance path. Note that the spring constant is more preferably set considering a position of the restricting section or a path change angle of the ink ribbon R.

Moreover, because the ink ribbon R is pressed down by the thermal head 42 during printing, a difference arises in tension applied, between the upstream side (supply side) and the downstream side (take-up side) of the ribbon conveyance path with reference to the thermal head 42, even with spring members having the same spring constant. Therefore, the spring constants can be selected considering the conveyance path (change in conveyance resistance, and so on) on the upstream side and the downstream side. In this way, it becomes possible for a. more appropriate tension to be applied to the ink ribbon R, and for a good printing result to be obtained.

Now, in order for an appropriate tension to be applied to, for example, all of a large variety of ink ribbons R Whose ribbon widths of the ink ribbon R are from 34 mm to 130 mm, the case is supposed where a stroke of extent “3.82/a*F1” is secured by the two spring members 47A, 47B.

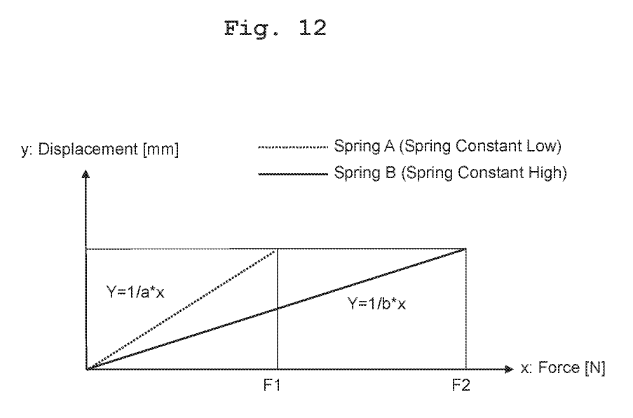

However, in the case of using only one spring member or the case of using two spring members having the same spring constant, if the spring constant is too small, the stroke will be insufficient. On the other hand, if the spring constant is too large, a sudden change in tension will occur, and as depicted in FIG. 12, the problem arises of being unable to apply an appropriate tension.

Now, a relationship between displacement y of the guide member and force x when the spring constant of spring member A has been set to a and the spring constant of spring member B has been set to b can be expressed by

y=1/a*x

y=1/b*x,

and can be depicted by the graph result of the kind depicted in FIG. 12.

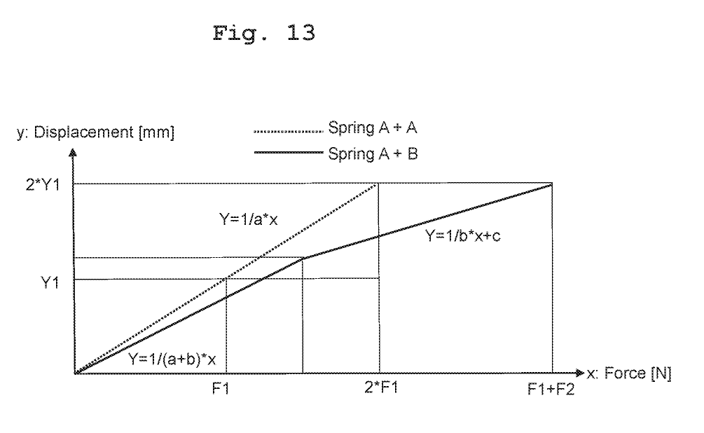

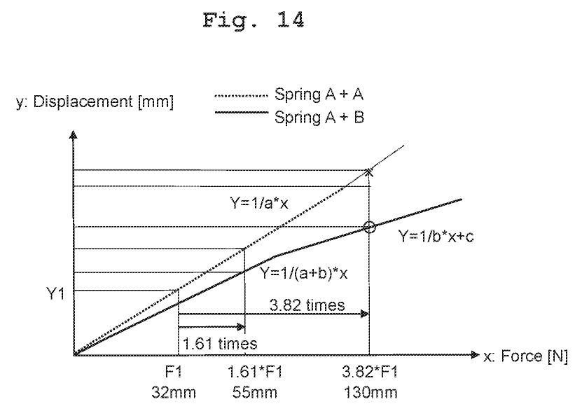

Moreover, a relationship between displacement y and force x in the case where two spring members A having spring constant a are used and the case where one each of the spring member A having spring constant a and the spring member B having spring constant b (spring constant a ≠ spring constant b) are used on either of the supply side or the take-up side, can be depicted by the graph result of the kind depicted in FIG. 13. Accordingly, by using two kinds of spring members whose spring constants differ as depicted in FIG. 14, it is possible for an appropriate tension to be applied to the ink ribbon R.

Note that in the above description, in the case of there being descriptions of the likes of “vertical”, “parallel”, “planar”, and “horizontal”, said descriptions are not used in a strict sense. That is, those “vertical”, “parallel”, “planar”, and “horizontal” allow for tolerance and error in design and manufacturing, and mean “substantively vertical”, “substantively parallel”, “substantively planar”, and “substantively horizontal”.

Moreover, in the above description, in the case of there being descriptions of apparent dimensions or sizes or speeds being “identical”, “equal”, “different”, and so on, said descriptions are not used in a strict sense. That is, those “identical”, “equal”, and “different” allow for tolerance and error in design and manufacturing, and mean “substantively identical”, “substantively equal”, and “substantively different”.

Moreover, techniques due to the above-described embodiment and each modified example may be utilized appropriately combined, besides what has already been described above.

In addition, although not exemplified, the present teaching may be implemented variously changed within a range not departing from the spirit of the teaching.

What is claimed is:

1. A printing apparatus comprising:
a ribbon supply roll configured to supply an ink ribbon;
a thermal head configured to print on an image receiving body, the thermal head being configured to heat the ink ribbon fed out from the ribbon supply roll and thereby transfer an ink onto the image receiving body from the ink ribbon;
a ribbon take-up roll configured to take up the ink ribbon after transfer of the ink;
a supply side guide member of shaft-like shape disposed in at least one place in a supply side conveyance path along which the ink ribbon is conveyed to the thermal head from the ribbon supply roll, the supply side guide member being configured to guide the ink ribbon and being disposed to be displaced in a direction orthogonal to an axial direction thereof, so as to changeably apply tension to the ink ribbon by biasing force of a supply side spring member; and
a take-up side guide member of shaft-like shape disposed in at least one place in a take-up side conveyance path along which the ink ribbon is conveyed to the ribbon take-up roll from the thermal head, the take-up side guide member being configured to guide the ink ribbon and being disposed to be displaced in a direction orthogonal to an axial direction thereof, so as to changeably apply tension to the ink ribbon by biasing force of a take-up side spring member,
wherein a spring constant of the supply side spring member is different from a spring constant of the take-up side spring member, and
the printing apparatus further comprising a supply side restricting section and a take-up side restricting section that are configured to restrict displacement of the supply side guide member and displacement of the take-up side guide member, in order, at certain positions, according to the spring constant of the supply side spring member and the spring constant of the take-up side spring member.

2. The printing apparatus according to claim 1, wherein
the spring constant of the supply side spring member is smaller than the spring constant of the take-up side spring member.

3. The printing apparatus according to claim 1, wherein the restricting sections execute restriction on an upper limit side of the take-up side guide member by the take-up side restricting section earlier than such restriction by the supply side restricting section.

4. The printing apparatus according to claim 1, wherein the supply side guide member and the take-up side guide member are each disposed so that the ink ribbon is doubled back at an acute angle.

5. A printing apparatus comprising
a cartridge and a cartridge base,
the cartridge comprising:
a ribbon supply roll shaft around which a supply side of an ink ribbon is wound in roll form;
a ribbon take-up roll shaft around which a take-up side of the ink ribbon is taken up in roll form;
a supply side guide member of shaft-like shape configured to contact the ink ribbon at one or more places on the supply side of the ink ribbon, the supply side guide member being configured to guide the ink ribbon in a conveyance direction orthogonal to a width direction of the ink ribbon;
a take-up side guide member of shaft-like shape configured to contact the ink ribbon at one or more places on the take-up side of the ink ribbon, the take-up side guide member being configured to guide the ink ribbon in the conveyance direction; and
a holder section configured to support the ribbon supply roll shaft and the ribbon take-up roll shaft in an independently rotatable manner and support the supply side guide member and the take-up side guide member in a manner enabling displacement in a direction orthogonal to an axial direction thereof, the axial direction being parallel with a width direction of the ink ribbon,
the cartridge base comprising:
a supply side roll shaft receiving section configured to support the ribbon supply roll shaft in a state of being abutted on by a tip of the ribbon supply roll shaft, so that a ribbon supply roll is wound;
a take-up side roll shaft receiving section configured to support the ribbon take-up roll shaft in a state of being abutted on by a tip of the ribbon take-up roll shaft, so that a ribbon take-up roll is taken up;
a supply side guide receiving section configured to support the supply side guide member in a state that the supply guide member penetrates the supply guide receiving section, so as to allow displacement of the supply side guide member;
a take-up side guide receiving section configured to support the take-up side guide member in a state that the take-up side guide member penetrates the take-up side guide receiving section, so as to allow displacement of the take-up side guide member;
a thermal head configured to heat the ink ribbon fed out from the ribbon supply roll and thereby transfer an ink onto an image receiving body from the ink ribbon;
a supply side spring member disposed in at least one place of a supply side conveyance path along which the ink ribbon is conveyed to the thermal head from the ribbon supply roll, the supply side spring member being configured to changeably apply tension to the ink ribbon by biasing the supply side guide member; and
a take-up side spring member disposed in at least one place of a take-up side conveyance path along which the ink ribbon is conveyed to the ribbon take-up roll from the thermal head, the take-up side spring member being configured to changeably apply tension to the ink ribbon by biasing the take-up side guide member,
wherein a spring constant of the supply side spring member is different from a spring constant of the take-up side spring member, and
the cartridge base comprises:
a supply side restricting section configured to restrict displacement of the supply side guide member at certain positions on an upper limit side and a lower limit side, according to the spring constant of the supply side spring member; and
a take-up side restricting section configured to restrict displacement of the take-up side guide member at certain positions on an upper limit side and a lower limit side, according to the spring constant of the take-up side spring member.
